(19) United States
(12) Patent Application Publication
(10) Pub. No.: US 2012/0186366 A1
(43) Pub. Date: Jul. 26, 2012

(54) MEASUREMENT OF MULTIMETALS AND TOTAL HALOGENS IN A GAS STREAM

(75) Inventors: Nicholas B. Lentz, Grand Forks, ND (US); John H. Pavlish, East Grand Forks, MN (US)

(73) Assignee: Energy & Environmental Research Center, Grand Forks, ND (US)

(21) Appl. No.: 13/358,240

(22) Filed: Jan. 25, 2012

Related U.S. Application Data
(60) Provisional application No. 61/436,499, filed on Jan. 26, 2011.

(51) Int. Cl. G01N 1/22; B01D 50/00; B01D 53/02

(52) U.S. Cl. 73/863.21; 96/152; 96/139

(57) ABSTRACT

A collection apparatus comprises a nozzle comprising an inlet for receiving at least a portion of a gas stream and an outlet, and at least one sorbent trap having an inlet in fluid communication with the outlet of the nozzle, wherein the sorbent trap comprises one or more collection media configured to collect at least one of a metal, an element, and a halogen present in the portion of the gas stream.

### CROSS-REFERENCE TO RELATED APPLICATIONS

This application claims priority to U.S. Provisional Patent Application Ser. No. 61/436,499, filed on Jan. 26, 2011, the disclosure of which is incorporated herein by reference in its entirety.

### STATEMENT REGARDING FEDERALLY SPONSORED RESEARCH OR DEVELOPMENT

This invention was made with government support under Cooperative Agreement Number DE-FC26-08NT43291 awarded by the Department of Energy. The government has certain rights in the invention.

### BACKGROUND

Currently, the only approved methodology in the United States for determining stack trace metal emissions is U.S. Environmental Protection Agency (EPA) Method 29. EPA Method 29 is a wet-impinger-based method that is labor-intensive and expensive and has a long turn-around time duration from sampling to results. Moreover, because EPA Method 29 involves solutions, there is an increased probability for sample contamination because of the sampling environment. The solutions also have to be transported to and from the sampling sites which requires appropriate hazard and temperature control systems to ensure sample preservation and a safe environment.

EPA Method 26A is a method that is typically used for halogen measurements. Both of EPA Methods 26A and 29 are impinger based, use wet hazardous chemicals, are cumbersome, are difficult to use, and are costly. These methods are less proven and even more difficult to use for gasification and oxycombustion systems.

One method that has been proposed uses a two-filter-based multimetal procedure coupled with x-ray fluorescence (XRF) analysis. The XRF method employs a set of two filters to sample for particulate and vapor-phase metals. The XRF method employs a reactive filter to capture vapor-phase elements. The XRF method is unable to directly analyze for beryllium or halogens due to XRF limitations with low-molecular-weight elements.

### SUMMARY OF THE INVENTION

The present disclosure is directed to a collection apparatus comprising a nozzle for collection of a sample from a gas stream that is coupled to a sorbent trap configured to absorb gas phase trace metals, elements, halogens, and hydrogen halides. The present disclosure is also directed to a method of taking samples from a gas stream, for example using the collection apparatus. The collection apparatus and method of the present disclosure can use dry, solid absorption structures within the sorbent trap so that the apparatus and method of the present disclosure do not require the use of solvents or solutions during the sampling process, unlike EPA Methods 29 or 26A, making the apparatus and method of the present disclosure easier to apply in the field.

An example is directed to a collection apparatus having a nozzle comprising an inlet for receiving at least a portion of a gas stream and an outlet, and at least one sorbent trap having an inlet in fluid communication with the outlet of the nozzle, wherein the sorbent trap comprises one or more collection media configured to absorb at least one of a metal, an element, and a halogen present in the portion of the gas stream.

An example is directed to a method of sampling from a gas stream comprising sampling at least a portion of a gas stream, receiving the portion of the gas stream in at least one sorbent trap, and absorbing at least one of a metal, an element, and a halogen present in the portion of the gas stream.

This summary is intended to provide an overview of subject matter of the present disclosure. It is not intended to provide an exclusive or exhaustive explanation of the disclosure. The detailed description is included to provide further information about the present disclosure.

### BRIEF DESCRIPTION OF THE DRAWINGS

FIG. 1 is a side view of an example collection apparatus comprising an isokinetic nozzle coupled to a sorbent trap.

FIG. 2 is a side view of another example collection apparatus comprising an isokinetic nozzle coupled to a sorbent trap.

FIG. 3 is side view of an example junction for coupling an isokinetic nozzle to a sorbent trap.

FIG. 4 is a flow chart showing an example method for collecting a sample from a gas stream.

FIGS. 5A-5D are charts showing data from a pilot-scale coal combustion operation comparing a multimetal and element collection apparatus comprising an isokinetic nozzle and a sorbent trap to Environmental Protection Agency Method 29.

FIGS. 6A-6C are charts showing data from a pilot-scale coal oxycombustion operation comparing a multimetal and element collection apparatus comprising an isokinetic nozzle and a sorbent trap to Environment Protection Agency Method 29.

FIG. 7 is a chart showing data from three sample runs from a pilot-scale coal combustion operation of an HCl collection apparatus comprising an isokinetic nozzle and a sorbent trap to Environmental Protection Agency Method 26A.

FIG. 8 is a chart showing data from three sample runs from a pilot-scale coal combustion operation of an HBr collection apparatus comprising an isokinetic nozzle and a sorbent trap to Environmental Protection Agency Method 26A.

FIG. 9 is a chart showing data from a full-scale coal combustion operation comparing a multimetal and element collection apparatus comprising an isokinetic nozzle and a sorbent trap to Environmental Protection Agency Method 29.

FIG. 10 is a chart showing data from a full-scale coal combustion operation comparing a HCl collection apparatus comprising an isokinetic nozzle and a sorbent trap to Environmental Protection Agency Method 26A.

### DETAILED DESCRIPTION OF THE INVENTION

The present disclosure describes a new, improved, simpler sorbent trap (ST) method and apparatus that can measure trace metals, elements, and halogens in combustion, oxycombustion, and gasification systems. Applications of the disclosed method also include, but are not limited to, use with coal-fired utilities, oil-burning utilities, waste-burning facilities, coal—biomass blends, etc.

The dry sorbent-trap-based apparatus and method disclosed herein can provide for the measurement of trace metals/elements (such as mercury, antimony, arsenic, beryllium, cadmium, chromium, cobalt, lead, boron, mangangese, nickel, copper, phosphorus, and selenium, etc.), halogens (such as chlorine, fluorine, and bromine), and hydrogen halides (such as hydrogen chloride and hydrogen fluoride) emitted from combustion, oxycombustion, and gasification reactions, such as in utility boilers. The apparatus and method can incorporate an isokinetic nozzle equipped with a solids collection device that is connected to a sorbent trap configured to absorb gas phase trace metals, elements, halogens, and hydrogen halides. The apparatus and method of the present disclosure uses dry solid absorption structures within the sorbent trap. Therefore, the apparatus and method of the present disclosure does not require the use of solvents or solutions during the sampling process, unlike EPA Methods 26A or 29, making the apparatus and method of the present disclosure easier to apply in the field.

An example apparatus comprises a nozzle for gas and particulate collection, such as an isokinetic nozzle and at least one of a solid-phase multimetal, element, or halogen collection device or a gas-phase multimetal, element, or halogen collection device. In an example, the apparatus comprises both a solid-phase collection device and a gas-phase collection device in order to collect and measure total flue gas emissions from the gas stream being sampled. In an example, any aerosol-phase multimetal, element, or halogen contained within the sample gas will be either collected in the solid and/or gas-phase device. In an example, the apparatus incorporates a gas stream collection device, such as an isokinetic nozzle, coupled onto the end of one or more sorbent traps, such as a single sorbent trap configured to collect all of the materials of interest from the gas stream or a series of sorbent traps that collectively retain all of the materials of interest. The combination of the nozzle and the sorbent trap can be constructed from a single piece of material or can comprise two or more pieces joined together by one or more unions.

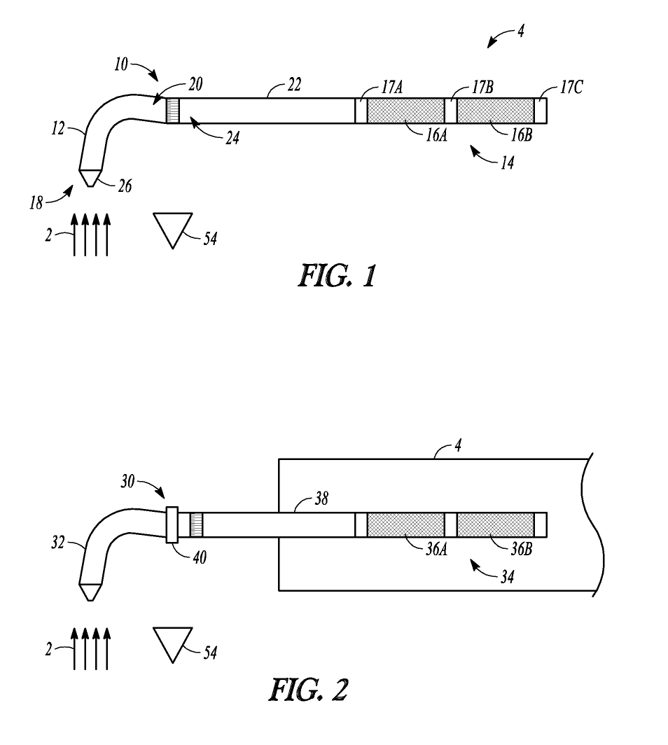

FIG. 1 shows a side view of an example collection apparatus 10 for the collection of a sample from a gas stream 2, such as a flue gas from a combustion, an oxycombustion, or a gasification system, in order to test for trace metals, elements, or halogens. The apparatus 10 can be mounted to a probe 4 in order to position the collection apparatus 10 within the gas stream 2. In an example, the collection apparatus 10 can be mounted to the probe 4 by at least one of adhesion, compression fitting, a union, sleeves, and the like. In an example, the collection device 10 and the probe 4 are inserted through a port in a gas transmission line through which the gas stream 2 is fed.

In an example, the collection apparatus 10 comprises a nozzle 12 and at least one sorbent trap 14 in fluid communication with the nozzle 12. The sorbent trap 14 comprises at least one collection media 16A, 16B configured for the absorption or collection of trace metals, elements, or halogens that can be present in a flue gas resulting from, for example, a combustion system, an oxycombustion system, or a gasification system. As used herein, “absorb” or “collect” with respect to collection media 16A, 16B, can refer to absoption of a material, adsorption of a material, or collection of a material by a collection medium 16A, 16B. As used herein, the term “trace metals” or “multimetals” can refer to metals or metalloids that can be regulated, for example by the United States Environmental Protection Agency (EPA), with respect to gas emissions, for example as in EPA Method 29, such as antimony (Sb), arsenic (As), barium (Ba), beryllium (Be), boron (B), cadmium (Cd), chromium (Cr), cobalt (Co), copper (Cu), lead (Pb), manganese (Mn), mercury (Hg), nickel (Ni), silver (Ag), thallium (Tl), or zinc (Zn). As used herein, the term “element” can refer to a solid element that is regulated, for example by the EPA, with respect to gas emissions, for example as in EPA Method 29, such as phosphorus (P) and selenium (Se). As used herein, the term “halogen” can refer to elemental halogens or hydrogen halides that are regulated, for example by the EPA, with respect to gas emissions, for example as in EPA Method 26A, such as fluorine (F₂), chlorine (Cl₂), bromine (Br₂), iodine (I), hydrogen fluoride (HF), hydrogen chloride (HCl), hydrogen bromide (HBr), and hydrogen iodide (HI).

In an example, the at least one collection media 16A, 16B are configured to absorb or collect a particular subset of the multimetals, elements, and halogens described above, which leaving the remaining multimetals, elements, and halogens unabsorbed and uncollected. In an example, a user may configure the collection media 16A, 16B, such as by selecting the materials, size, positioning, or configuration of the collection media 16A, 16B, to absorb or collect any combination of multimetals, elements, or halogens that are desired to be sampled and measured from the gas stream 2. In an example, the at least one collection media 16A, 16B are configured to absorb all of the multimetals, elements, and halogen listed above that are present in the gas stream 2.

The nozzle 12 comprises an inlet 18 and an outlet 20. The at least one sorbent trap 14 can comprise a sorbent trap housing 22 having an inlet 24 that is in fluid communication with the nozzle outlet 20. In an example, the nozzle 12 provides for isokinetic sampling of the gas flow 2. In an example, isokinetic sampling allows for loading of solid-phase particulates in proportion to the amount of the solid-phase particulates that are in the gas stream 2. In an example, isokinetic sampling also allows for loading of entrained water droplets that may be present in the gas stream 2, where the entrained water droplets may comprise dissolved metals, elements, or halogens, such as hydrogen halides dissolved in the water droplets forming acid particulate matter. As used herein, the term “isokinetic” refers to a gas velocity at the nozzle inlet 18 being substantially equal to the velocity of gas flowing within the gas stream 2 around the nozzle 12. In an example, the gas velocity of the sample in the nozzle 12 will be considered “substantially equal,” and thus “isokinetic,” when the gas velocity in the nozzle 12 is within about 20% of the gas velocity of the gas stream 2, such as within about 10% of the gas velocity of the gas stream 2. In an example, the sampled gas remains isokinetic as it passes from the nozzle 12 to the sorbent trap 14 and the collection media 16A, 16B. In an example, an angled port (not shown) can be used in place of an isokinetic nozzle 12, so long as the angled port is sized for isokinetic sampling of the gas stream 2.

In an example, shown in FIG. 1, the isokinetic nozzle 12 comprises an isokinetic tip 26 through which a portion of the gas stream 2 can enter the isokinetic nozzle 12. In an example, the isokinetic nozzle 12 has a generally uniform and constant cross-sectional shape and area from the nozzle tip 26 to the nozzle outlet 20, such as a generally circular cross-section. As shown in FIG. 1, the nozzle 12 can comprise a bend 27, where the shape and geometry of the bend 27 provides for isokinetic sampling from the gas stream 2. The example isokinetic nozzle 12 with the bend 27 shown in FIG. 1 is sometimes referred to as a “button-hook” nozzle. In an example, the nozzle 12 provides for isokinetic sampling of gases in accordance with EPA Method 5, 40 CFR 60, Appendix A (last revised February 2000), the entirety of the disclosure of which is incorporated by reference as if reproduced herein. In an example, the dimensions, size, shape, and configuration of the nozzle 12 can be selected to correspond to the expected flow rate or gas velocity of the gas stream 2. Examples of nozzles that can be used as the isokinetic nozzle 12 include isokinetic nozzles manufactured by Clean Air Engineering, Inc. (Palatine, Ill., USA) or Apex Instruments, Inc. (Fuquay-Varina, N.C., USA).

In an example, the sorbent trap 14 comprises a plurality of absorbent media 16A, 16B, wherein each medium 16A, 16B is configured to absorb one or more of the multimetals, elements, or halogens that may be present in the gas stream 2. Each collection media 16A, 16B can be configured to target collection and analysis of different multimetals, elements, or halogens. For example, a first collection medium 16A can be configured to target collection of a first set of multimetals, elements, or halogens, while a second collection medium 16B can be configured to target collection of a second set of multimetals, elements, or halogens. In another example, the first collection medium 16A can be configured to collect multimetals of interest, while the second collection medium 16B can be configured to collect elements of interest, and a third collection medium (not shown) can be configured to collect halogens of interest. In yet another example, the first collection medium 16A and the second collection medium 16B can both be configured to collect any or all of the trace materials that are to be sampled by the collection apparatus 10, e.g., such that each of media 16A, 16B collect a portion or percentage of the multimetals, elements, and halogens that are present in the gas stream 2. In an example, the first collection medium 16A and the second collection medium 16B can both be configured to collect any or all of the trace materials that are to be sampled by the collection apparatus 10, e.g., such that the first collection media 16A is configured to collect all of the multimetals, or all of the elements, or all of the halogens and the second collection medium 16B is configured to act as a backup media to collect any multimetals, or elements, or halogens that penetrated through the first collection medium 16A. In an example, each collection medium 16A, 16B can comprise a single media segment or a plurality of media segments.

In an example, parameters of the collection media 16A, 16B that can affect collection of the multimetals, elements, and halogens include, but are not limited to, average pore size, pore size distribution, pore density (also referred to as void space), reactivity or affinity to a particular analyte (e.g., a particular multimetal, a particular element, or a particular halogen), the vacuum that can be created by the sorbent material (e.g., the pressure that must be overcome for the collection apparatus 10 to collect a sample of the gas stream 2), and the temperature of the absorption media 16A, 16B.

The material of each collection medium 16A, 16B can be selected to absorb one or more of the analytes in the gas stream 2 that are desired to be sampled, such as one or more of the multimetals, one or more of the elements, one or more of the halogens, a combination of one or more multimetals and one or more elements, a combination of one or more multimetals and one or more halogens, a combination of one or more elements and one or more halogens, or a combination of one or more multimetals, one or more elements, and one or more halogens. In an example, the material of each collection medium 16A, 16B can be selected to collect the particular analytes of interest in the presence of other materials that may be present in the gas stream 2, while not absorbing the other materials in the gas stream 2. In an example, the material of each collection medium 16A, 16B can be selected to maintain the analyte or analytes that are collected, e.g., the multimetals, elements, or halogens, without altering the analyte or analytes, for example without causing or facilitating a reaction involving the absorbed material or without causing or facilitating a physical change of the absorbed material, such as a change of state. In an example, the material of each collection medium 16A, 16B can be selected so that the collected analyte, e.g., multimetals, elements, or halogens, can be desorbed from the collection medium 16A, 16B in order to allow for testing of concentrations or amounts of the absorbed analyte in the gas stream 2.

Examples of sorbent materials that may be used to form the collection media 16A, 16B include, but are not limited to, activated carbon, clay-based materials, alkali based materials (e.g. sodium bicarbonate), silica gel, organic porous polymers, and zeolite.

The sorbent trap 14 can also include one or more plugs 17A, 17B, 17C that can be positioned within the sorbent trap housing 22 on either side of collection media 16A, 16B. In some examples, the plugs 17A, 17B, 17C can provide for positioning of the collection media 16A, 16B within the sorbent trap housing 22, for example to ensure that the absorbent media 16A, 16B are placed at a selected position within the sorbent trap housing 22 or so that one collection media 16A is spaced by a selected distance from an adjacent absorbent media 16B. In an example, one or more of the plugs 17A, 17B, 17C are coupled to the sorbent trap housing 22, either by being attached to the sorbent trap housing 22, such as with a fastener or an adhesive, or by being integral with the sorbent trap housing 22, e.g., as a single piece or section of material.

In an example, one or more of the plugs 17A, 17B, 17C can comprise a filter for filtering out components of the gas stream 2 that are undesired to pass into the collection media 16A, 16B, such as to separate solid-phase materials from gas-phase materials, for example to facilitate separation of particulate-bound or specific forms of metals, element, or halogens. Each plug 17A, 17B, 17C can also comprise a spacer material, a liquid, or a gas. Examples of materials that could be used to make the plugs 17A, 17B, 17C include, but are not limited to, fibers, quartz, nitrocelluouse, and Teflon.

In an example, a back end or outlet 19 of the sorbent trap 14 allows at least a portion of the sampled gas stream to flow out of the sorbent trap 14. In an example, the outlet 19 can be connected to a fluid flow device, such as a pump (not shown), that draws the sample gas from the gas stream 2 through the nozzle 12, into the sorbent trap 14, and out through the outlet 19. A flow meter (not shown) can also be coupled to the outlet 19 to measure the flow rate through the sorbent trap 14 over time.

In an example, shown in FIG. 1, the nozzle 12 and the sorbent trap housing 22 can be formed from the same piece of material, e.g., the collection apparatus 10 can have a unibody construction. A unibody collection apparatus 10 can be made from quartz or another material, such as stainless steel, Teflon coated alloys, metals, or other materials.

A collection apparatus can also be made from separate components that are connected together. FIG. 2 shows a side view of another example collection apparatus 30. Like the collection apparatus 10 shown in FIG. 1, the collection apparatus 30 shown in FIG. 2 comprises a nozzle 32, such as an isokinetic nozzle, for receiving at least a portion of the gas stream 2, and a sorbent trap 34 comprising at least one collection medium 36A, 36B within a sorbent trap housing 38. However, rather than a unibody collection apparatus 10, as in FIG. 1, the nozzle 32 and the sorbent trap housing 38 of the collection apparatus 30 are made from separate pieces of material that are coupled together.

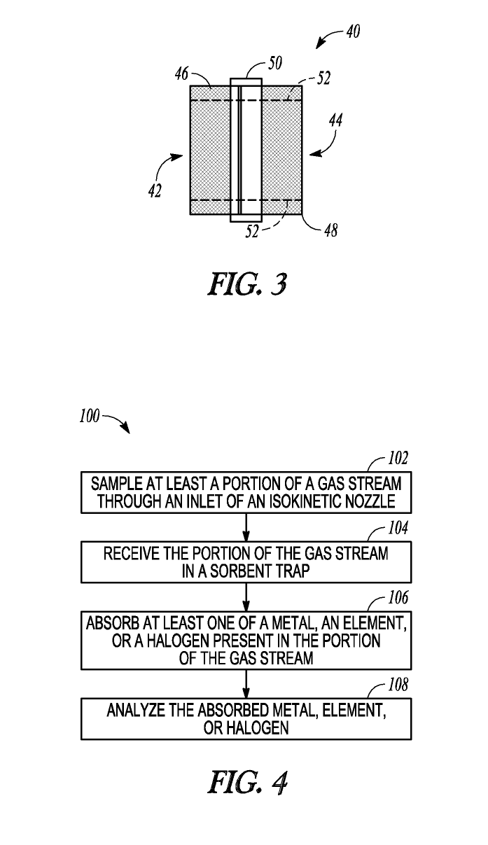

In an example, the nozzle 32 and the sorbent trap housing 38 are coupled together with a union 40. FIG. 3 shows a side view of an example union 40 that can be used to couple the nozzle 32 to the sorbent trap housing 38. In an example, the union 40 comprises a first side or front side 42 that is coupled to the nozzle 32 and a second side or back side 44 that is coupled to the sorbent trap housing 38. In an example, shown in FIG. 3, the union 40 comprises a front stem 46, a back stem 48, and a flange 50 between the front stem 46 and the back stem 48. The front stem 46 is on the front side 42 of the union 40 and can be inserted into a bore of the nozzle 32 to facilitate coupling between the nozzle 32 and the union 40. Similarly, the back stem 48 is on the back side 44 of the union 40 and can be inserted into a bore of the sorbent trap housing 38. The flange 50 can have a larger diameter (and cross-sectional area) than both stems 46, 48 so that the nozzle 32 and the sorbent trap housing 38 will be positioned properly with respect to one another by way of the union 40. In an example, the union 40 may be coupled to each of the nozzle 32 and the sorbent trap housing 38 by any method that provides for a physical connection while still allowing a gas to flow through a lumen 52 in the union 40 from the nozzle 32 to the sorbent trap 34, such as with a fastener, a coupling, or an adhesive. Other methods of coupling the nozzle 32 to the sorbent trap 34 can be used, such as coupling the nozzle 32 directly to the sorbent trap 34, such as a threaded engagement between an inner diameter of the nozzle 32 and an outer diameter of the sorbent trap housing 38 or vice versa (between an outer diameter of the nozzle 32 and an inner diameter of the sorbent trap housing 38).

The multi-component collection apparatus 30 of FIG. 2 can provide for modular adjustment of the collection apparatus 30, such as by providing for easier modification of the size, dimensions, or materials of the nozzle 32, the sorbent trap 34 (including the collection media 36A, 36B), the sorbent trap housing 38, and the union 40. For example, the multi-component collection apparatus 30 can allow for removal of a first nozzle 32 and the installation of a second nozzle (not shown) having a different geometry, a difference size, or of a different material. Similarly, the multi-component configuration of the collection apparatus 30 allows difference components, e.g., the nozzle 32, the sorbent trap housing 38, and the union 40, to be made from different materials, which can be useful, for example, to accommodate different thermal expansion within the gas stream 2 versus outside of the gas stream 2. Examples of materials that can be used to make each of the nozzle 32, the sorbent trap housing 38, and the union 40 include, but are not limited to, quartz, stainless steel, Teflon coated alloys, metals, or other materials.

In an example, the collection apparatus 10 can also comprise a nozzle plug or cap 54 that can be fitted onto the tip 18 of the nozzle 12 in order to close or seal the nozzle 12, as shown in FIG. 1. The nozzle plug or cap 54 allows a user to close off the collection apparatus 10 after taking a sample from the gas stream 2 while the collection apparatus 10 is transported to a laboratory for analysis. In an example, the plug or cap 54 can provide for an interference fit with the nozzle tip 18, such as by an inner diameter of the cap 54 forming an interference fit with an outer diameter of the nozzle tip 18. In an example, a cap 54 may be threading on an interior surface that engages corresponding threading on an exterior surface of the nozzle tip 18. In another example, a plug may fit within the opening in the nozzle tip 18 in order to close or seal the nozzle tip 18.

FIG. 4 is a flow chart of an example method 100 of sampling from a gas stream 2. In an example, the method 100 comprises, at 102, sampling at least a portion of a gas stream 2 through an inlet 18 of a nozzle 12. In an example, the nozzle 12 can be configured so that the sampled portion of the gas stream 2 is sampled isokinetically, e.g., so that the gas velocity of the sample within the nozzle 12 is substantially equal to the gas velocity within the gas stream 2. In an example, the configuration (e.g., geometry and size) of a tip 26 (FIG. 1) of the nozzle 12 can provide for isokinetic sampling. In an example, the flow rate of the sample gas can be increased or decreased through the tip 26 by changing the flow through the nozzle 12 and the sorbent trap 14, for example by varying a speed of a pump (not shown), e.g., a pump connected to the outlet 19, or by changing settings of a control valve (not shown), for example a control valve that is connected to the outlet 19 to control the flow rate from the outlet 19.

At 104, after sampling the portion of the gas stream 2, the portion of the gas stream 2 is received in a sorbent trap 14. In an example, receiving the portion of the gas stream 2 in the sorbent trap 14 comprises receiving the portion of the gas stream 2 from an outlet 20 of the nozzle 12 through an inlet 24 of a sorbent trap housing 22.

In an example, the method 100 further includes, at 106, collect at least one of a multimetal, an element, or a halogen present in the portion of the gas stream 2. The multimetal, element, or halogen can be present in a flue gas from a combustion system, an oxycombustion system, or a gasification system. In an example, the at least one of the multimetal, element or the halogen is collected by one or more collection media 16A, 16B (FIG. 1) The at least one of the multimetal, element, or the halogen can also be separated out, for example by a plug 17A, 17B, or 17C (FIG. 1). In an example, absorbing the at least one metal in the sorbent trap 14 can comprise absorbing at least one of antimony (Sb), arsenic (As), barium (Ba), beryllium (Be), boron (B), cadmium (Cd), chromium (Cr), cobalt (Co), copper (Cu), lead (Pb), manganese (Mn), mercury (Hg), nickel (Ni), silver (Ag), thallium (Tl), and zinc (Zn). In an example, absorbing the at least one element in the sorbent trap 14 can comprise absorbing at least one of phosphorus (P) and selenium (Se). In an example, absorbing the at least one halogen can comprise absorbing at least one of chlorine (Cl₂), fluorine (Fl₂), bromine (Br₂), iodine (I), hydrogen chloride (HCl), hydrogen fluoride (HF), hydrogen bromide (HBr), and hydrogen iodide (HI).

In an example, the method 100 can comprise absorbing each of antimony (Sb), arsenic (As), barium (Ba), beryllium (Be), boron (B), cadmium (Cd), chromium (Cr), cobalt (Co), copper (Cu), lead (Pb), manganese (Mn), mercury (Hg), nickel (Ni), silver (Ag), thallium (Tl), zinc (Zn), phosphorus (P), selenium (Se), fluorine (F₂), chlorine (Cl₂), bromine (Br₂), iodine (I), hydrogen fluoride (HF), hydrogen chloride (HCl), hydrogen bromide (HBr), and hydrogen iodide (HI), if present in the sampled portion of the gas stream 2.

At 108, the method 100 can also comprise analyzing the collected material of at least one metal, element, or halogen. Analyzing can include, for example, determining the concentration or amount of each metal, element, or halogen in the gas stream 2. In an example, analyzing the collected metal, element, or halogen can comprise desorbing the at least one metal, element, or halogen and analyzing the desorbed material, for example using standard analyte analytical techniques, to determine an amount or concentration of each metal, element, or halogen that is desorbed. The collection apparatuses 10 and 30 and method 100 of the present disclosure can significantly simplify the amount of work required for collection of trace multimetals, elements, or halogens within a gas stream 2. The collection apparatuses 10 and, 30 and method 100 can also reduce expenses and sample analysis turn-around time.

As described above, the collection apparatuses 10 and 30 can be a dry collection apparatus comprising only substantially dry components and the method 100 can be a dry method that does not require any solvents or chemicals at the sampling site. The ability to collect samples of the gas stream 2 without the use of solvents or chemicals reduces the time required for the method 100, particularly with respect to sample recovery, because no solutions have to be prepared, measured, or transferred to impinger trains, as with EPA Methods 26A and 29. The cost can also be significantly reduced because chemicals do not have to be purchased, shipped, or disposed of at the test site. Sample analysis turn-around time can also be significantly reduced because the sample can either be analyzed on-site or shipped, such as via overnight mail, to a qualified lab. Moreover, the sample can be packaged and shipped easily because the one or more sorbent traps 14, 34 or the combination of the sorbent trap or traps 14, 34 and the nozzle 12, 32 are small in size, are easy to seal or package, and do not contain any hazardous chemicals that require special handling, such as solvents. In particular, the collection apparatuses 10 and 30 and the method 100 can provide a cost-effective sampling method for small boilers. In addition, the collection apparatuses 10 and 30 can provide for a simple and low-cost method 100 for sampling and measuring trace metals, elements, and halogen emissions from combustion, oxycombustion, and gasification systems.

### EXAMPLES

### Example 1

Pairs of collection apparatuses each comprising an isokinetic nozzle and a sorbent trap with one or more collection media, which can be similar to the collection apparatus 10 comprising an isokinetic nozzle 12 and a sorbent trap 14 having collection media 16A, 16B, were used to collect four pairs of samples, with a first two pairs of samples being collected from the flue gas of a first coal combustion facility, and a second two pairs of samples being collected from the flue gas of a second coal combustion facility. An EPA Method 29 sample of the flue gas was also taken substantially simultaneously with each pair of sorbent trap collection apparatus samples in order to compare the results from the collection apparatus samples to the standard EPA Method 29 sample. The samples from each pair of collection apparatuses and the M29 sample were taken at an outlet of an electrostatic precipitator of a pilot-scale coal combustor running a combustion operation.

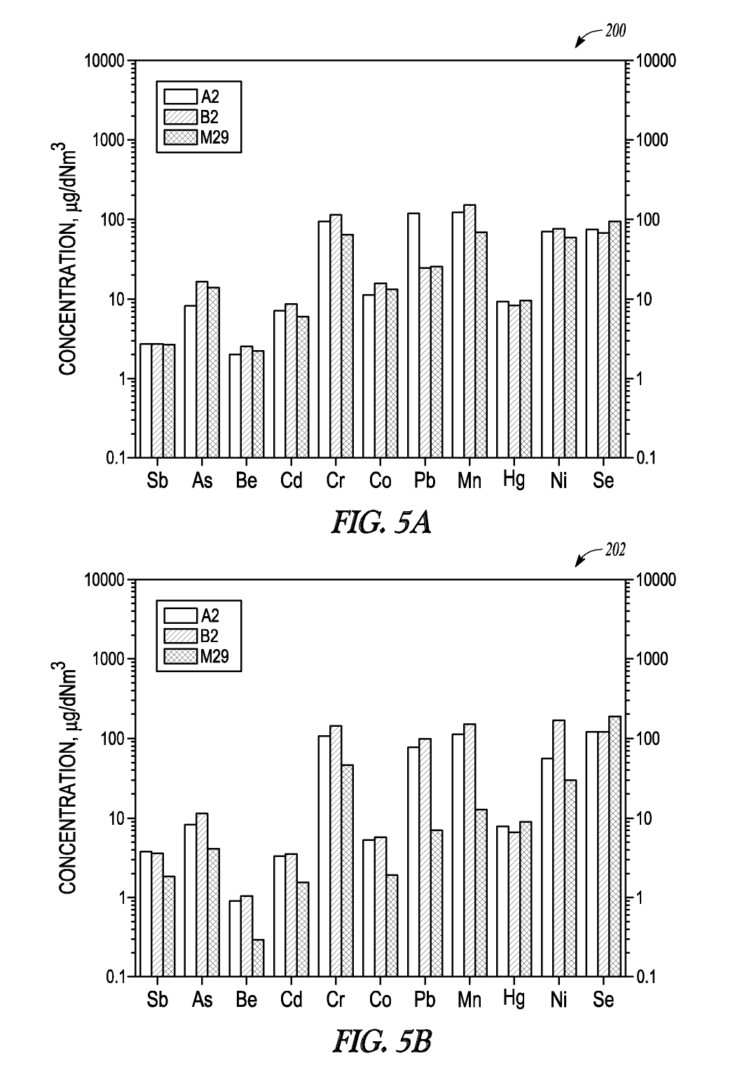

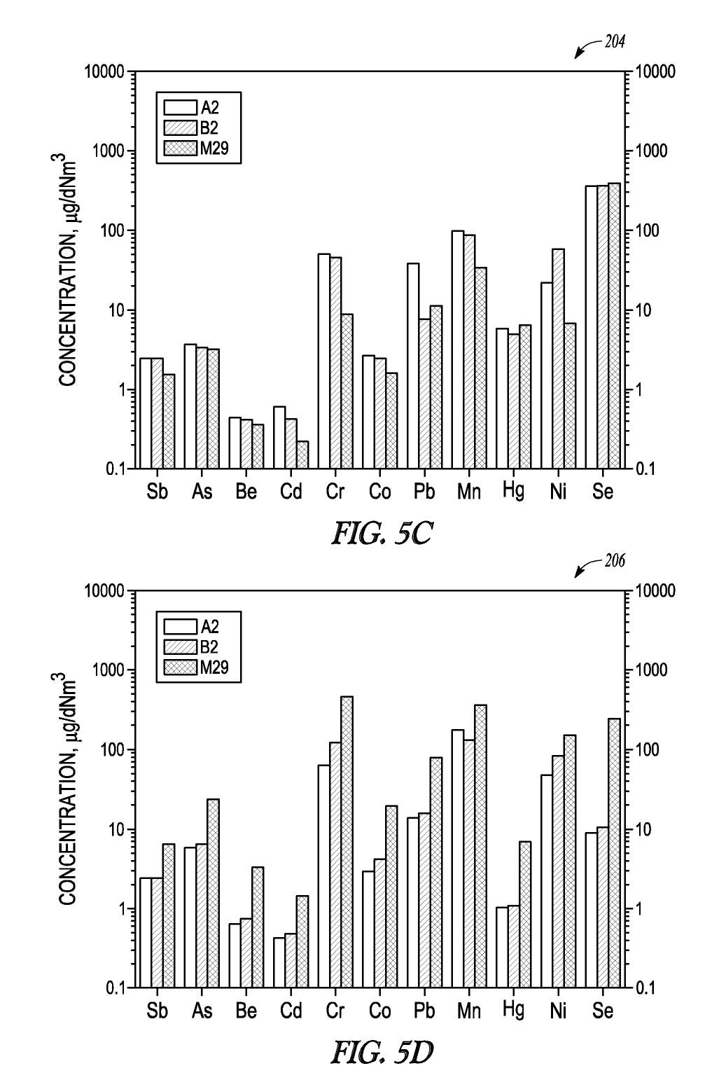

FIGS. 5A-5D show examples of data sets from samples collected by each pair of the collection apparatuses compared to the data from the corresponding EPA Method 29 samples. FIG. 5A shows an example of a first set of data 200 from a first pair of the collection apparatuses compared to the EPA Method 29 data taken at a first facility. According to the legend, “A1” refers to component concentration data from a first collection apparatus for each of the multimetals or elements sampled (no halogens were sampled for this Example), “B1” refers to component concentration data from a second collection apparatus for each of the multimetals or elements, and “M29” refers to component concentrations for each of the multimetals or elements from the Method 29 samples. FIGS. 5B-5D show similar examples of data sets 202, 204, and 206 that can be collected from a second pair of collection apparatuses and for a Method 29 sample taken at the first facility (FIG. 5B), a first pair of collection apparatuses and a Method 29 sample taken at a second facility (FIG. 5C), and a second pair of collection apparatuses and a Method 29 sample taken at the second facility (FIG. 5D).

### Example 2

Three pairs of collection apparatuses each comprising an isokinetic nozzle and a sorbent trap with one or more collection media, (e.g., similar to the collection apparatus 10 comprising an isokinetic nozzle 12 and a sorbent trap 14 having collection media 16A, 16B) were used to collect three pairs of samples, with each pair of samples being collected from the flue gas of a pilot-scale coal combustor from an oxycombustion operation. An EPA Method 29 sample of the flue gas was also taken substantially simultaneously with each pair of sorbent trap collection apparatus samples in order to compare the results from the collection apparatus samples to the standard EPA Method 29 sample. The samples from each pair of collection apparatuses and the M29 sample were taken at an outlet of an electrostatic precipitator of a pilot-scale coal combustor.

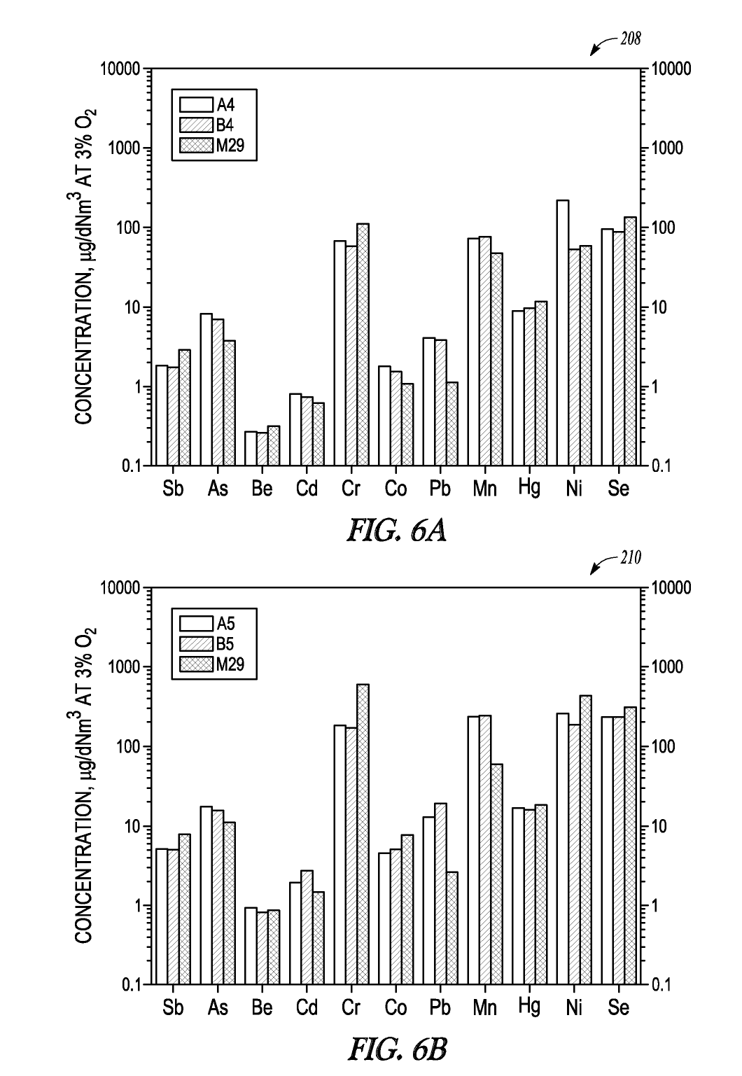

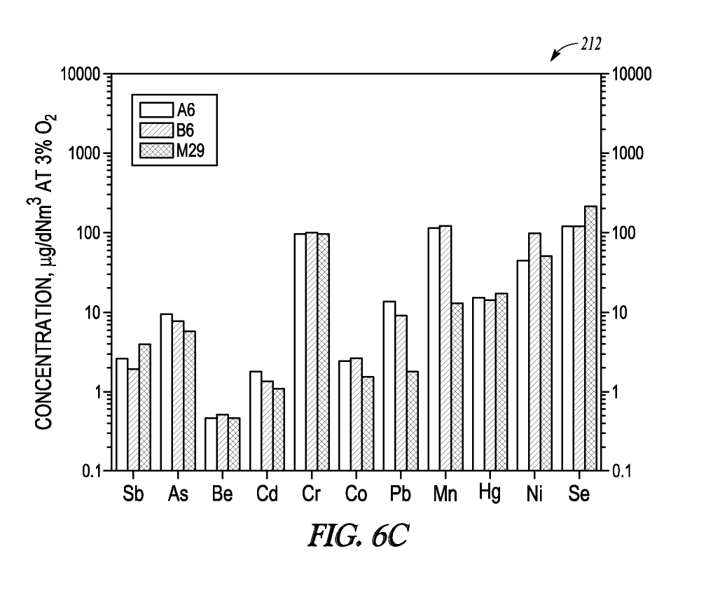

FIGS. 6A-6C show examples of data sets from samples collected by each pair of the collection apparatuses for the oxycombustion operation compared to the data from the corresponding EPA Method 29 samples. FIG. 6A shows an example of a first set of data 208 from a first pair of the collection apparatuses compared to the EPA Method 29 data taken at a first facility. According to the legend, “A5” refers to component concentration data from a first collection apparatus for each of the multimetals or elements sampled (no halogens were sampled for this Example), “B5” refers to component concentration data from a second collection apparatus for each of the multimetals or elements, and “M29” refers to component concentrations for each of the multimetals or elements from the Method 29 samples. FIGS. 6B and 6C show similar examples of data sets 210 and 212 that can be collected from a second pair of collection apparatuses and for a Method 29 sample of the oxycombustion operation (“A6,” and “B6” in FIG. 6B) and a third pair of collection apparatuses and a Method 29 sample of the oxycombustion operation (“A7” and “B7” FIG. 6C).

### Example 3

A pair of collection apparatuses each comprising an isokinetic nozzle and a sorbent trap with one or more collection media, (e.g., similar to the collection apparatus 10 comprising an isokinetic nozzle 12 and a sorbent trap 14 having collection media 16A, 16B) were used to collect pairs of samples, with each sample being collected from the flue gas of a pilot-scale coal combustor in order to analyze the HCl content in the flue gas. An EPA Method 26A sample of the flue gas was also taken substantially simultaneously with each pair of sorbent trap collection apparatus samples in order to compare the results from the collection apparatus samples to the standard EPA Method 26A sample. The samples from each pair of collection apparatuses and the M26A sample were taken at an outlet of an electrostatic precipitator of a pilot-scale coal combustor. Three separate sample trials or “runs” of the collection apparatuses and the M26A sample.

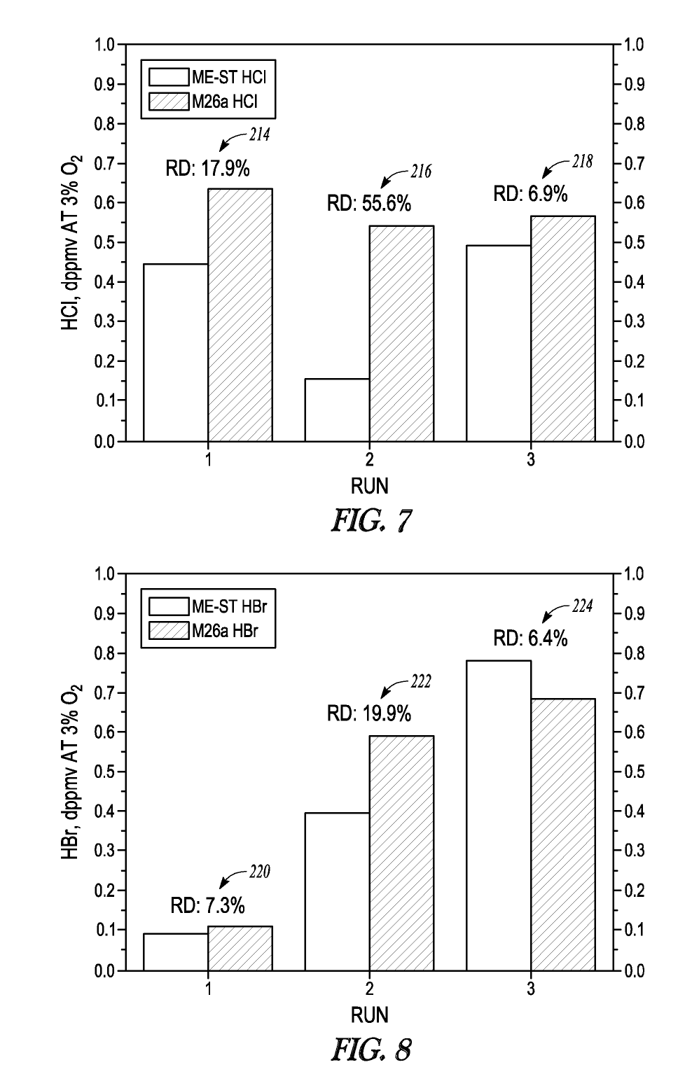

FIG. 7 shows examples of data sets 214, 216, 218 from the three sample runs collected by each pair of the collection apparatuses compared to the data from the corresponding EPA Method 26A samples. The data values labeled “CA HCl” in FIG. 7 represents the average of the two collection apparatuses, while the data labeled “M26A HCl” represents the Method 26A value determined for each sample run.

### Example 4

A pair of collection apparatuses each comprising an isokinetic nozzle and a sorbent trap with one or more collection media, (e.g., similar to the collection apparatus 10 comprising an isokinetic nozzle 12 and a sorbent trap 14 having collection media 16A, 16B) were used to collect pairs of samples, with each sample being collected from the flue gas of a pilot-scale coal combustor in order to analyze the HBr content in the flue gas. An EPA Method 26A sample of the flue gas was also taken substantially simultaneously with each pair of sorbent trap collection apparatus samples in order to compare the results from the collection apparatus samples to the standard EPA Method 26A sample. The samples from each pair of collection apparatuses and the M26A sample were taken at an outlet of an electrostatic precipitator of a pilot-scale coal combustor. Three separate sample trials or “runs” of the collection apparatuses and the M26A sample.

FIG. 8 shows examples of data sets 220, 222, 224 from the three sample runs collected by each pair of the collection apparatuses compared to the data from the corresponding EPA Method 26A samples. The data values labeled “CA HBr” in FIG. 8 represents the average of the two collection apparatuses, while the data labeled “M26A HBr” represents the Method 26A value determined for each sample run.

### Example 5

Pairs of collection apparatuses each comprising an isokinetic nozzle and a sorbent trap with one or more collection media, (e.g., similar to the collection apparatus 10 comprising an isokinetic nozzle 12 and a sorbent trap 14 having collection media 16A, 16B) were used to collect pairs of samples, with each sample being collected from the flue gas of a full-scale coal combustion facility to determine multimetal and element levels. An EPA Method 29 sample of the flue gas was also taken substantially simultaneously with each pair of sorbent trap collection apparatus samples in order to compare the results from the collection apparatus samples to the standard EPA Method 29 sample. The primary difference between Example 1 and Example 5 is that samples in Example 1 were taken from a pilot-scale combustor, while samples in Example 5 were taken from a full-scale combustor.

FIG. 9 shows an example data set 226 for multimetals and elements taken from the collection apparatuses and from the M29 samples. The data values labeled “CA” in FIG. 9 represent the average from nine (9) sample runs for the collection apparatuses, and the data values labeled “M29” represent the average from nine (9) substantially simultaneously collected M29 samples.

### Example 6

Pairs of collection apparatuses each comprising an isokinetic nozzle and a sorbent trap with one or more collection media, (e.g., similar to the collection apparatus 10 comprising an isokinetic nozzle 12 and a sorbent trap 14 having collection media 16A, 16B) were used to collect pairs of samples, with each sample being collected from the flue gas of a full-scale coal combustion facility to determine an HCl level. An EPA Method 26A sample of the flue gas was also taken substantially simultaneously with each pair of sorbent trap collection apparatus samples in order to compare the results from the collection apparatus samples to the standard EPA Method 26A sample. The primary difference between Example 3 and Example 6 is that samples in Example 3 were taken from a pilot-scale combustor, while samples in Example 6 were taken from a full-scale combustor.

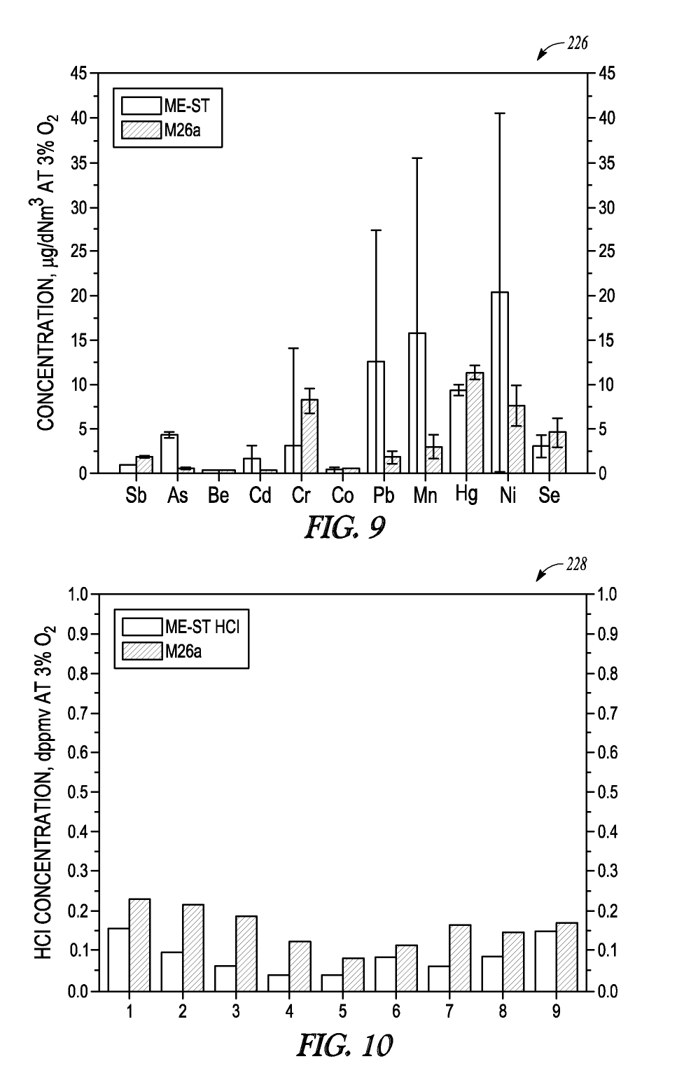

FIG. 10 shows an example data set 228 for multimetals and elements taken from the collection apparatuses and from the M26A samples. The data values labeled “CA HCl” in FIG. 10 represent the HCl levels from each of nine (9) sample runs for the collection apparatuses, and the data values labeled “M26A HCl” represent the HCl levels from a Method 26A analysis from each of nine (9) substantially simultaneously collected M26A samples.

As shown in FIGS. 5A-5D, 6A-6C, and 7-10, samples collected using the collection apparatuses provide for data that is substantially consistent with data collected by EPA Methods 26A and 29.

The accuracy of the collection apparatus 10 and the method 100 can be improved with further modification to the collection apparatus 10, such as materials of the nozzle 12, the sorbent trap 14, the collection media 16A, 16B and the plugs 17A, 17B, 17C, and through further experimentation and analysis. The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed example. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A collection apparatus comprising:
a nozzle comprising an inlet for receiving at least a portion of a gas stream and an outlet; and
at least one sorbent trap having an inlet in fluid communication with the outlet of the nozzle, wherein the sorbent trap comprises one or more collection media configured to absorb at least one of a metal, an element, and a halogen present in the portion of the gas stream.

2. The collection apparatus of claim 1, wherein the one or more collection media is configured to collect at least one of antimony, arsenic, barium, beryllium, cadmium, chromium, cobalt, copper, lead, manganese, mercury, nickel, phosphorus, selenium, silver, thallium, zinc, boron, fluorine, chlorine, bromine, iodine, hydrogen fluoride, hydrogen chloride, hydrogen bromide, and hydrogen iodide.

3. The collection apparatus of claim 1, wherein the one or more collection media is configured to collect each of antimony, arsenic, barium, beryllium, cadmium, chromium, cobalt, copper, lead, manganese, mercury, nickel, phosphorus, selenium, silver, thallium, zinc, boron, fluorine, chlorine, bromine, iodine, hydrogen fluoride, hydrogen chloride, hydrogen bromide, and hydrogen iodide.

4. The collection apparatus of claim 1, wherein the nozzle is an isokinetic nozzle.

5. The collection apparatus of claim 1, comprising a plug or cap for closing the nozzle.

6. The collection apparatus of claim 1, comprising a plug positioned at least one of upstream of the one or more collection media, downstream of the one or more collection media, or between adjacent collection media.

7. The collection apparatus of claim 6, wherein the plug comprises a filter, a porous solid, a liquid, or a gas.

8. The collection apparatus of claim 1, wherein the nozzle and the sorbent trap are formed as a single piece.

9. The collection apparatus of claim 1, comprising a union for coupling the nozzle and the sorbent trap.

10. The collection apparatus of claim 1, comprising a means for coupling the nozzle and the sorbent trap.

11. The collection apparatus of claim 1, comprising a means for coupling the collection device to a probe.

12. The collection apparatus of claim 1, wherein the means for coupling the collection device to the probe comprises at least one of a fastener, a coupling, compression fitting, and an adhesive.

13. A method of sampling from a gas stream comprising:
sampling at least a portion of a gas stream;
receiving the portion of the gas stream in at least one sorbent trap;
collecting at least one of a metal, an element, and a halogen present in the portion of the gas stream.

14. The method of claim 13, wherein collecting at least one of the metal, the element, or the halogen comprises absorbing at least one of antimony, arsenic, barium, beryllium, cadmium, chromium, cobalt, copper, lead, manganese, mercury, nickel, phosphorus, selenium, silver, thallium, zinc, boron, fluorine, chlorine, bromine, iodine, hydrogen fluoride, hydrogen chloride, hydrogen bromide, and hydrogen iodide.

15. The method of claim 13, wherein collecting at least one of the metal, the element, or the halogen comprises absorbing each of antimony, arsenic, barium, beryllium, cadmium, chromium, cobalt, copper, lead, manganese, mercury, nickel, phosphorus, selenium, silver, thallium, zinc, boron, fluorine, chlorine, bromine, iodine, hydrogen fluoride, hydrogen chloride, hydrogen bromide, and hydrogen iodide.

16. The method of claim 13, wherein the sampling comprises sampling at least the portion of the gas stream through a nozzle.

17. The method of claim 16, wherein the portion of the gas stream in at least one sorbent trap is received from an outlet of the nozzle.

18. The method of claim 13, wherein the sampling comprises isokinetically sampling the portion of the gas stream.

19. The method of claim 18, wherein the isokinetic sampling comprises sampling at least the portion of the gas stream through an isokinetic nozzle.

20. The method of claim 13, comprising analyzing the collected metal, element, or halogen.
